(19) United States
(12) Patent Application Publication
(10) Pub. No.: US 2020/0121418 A1
(43) Pub. Date: Apr. 23, 2020

(54) VIBRATION APPARATUS FOR DENTAL CARE

(71) Applicant: B&L BIOTECH, INC., Ansan-si (KR)

(72) Inventor: In Whan LEE, Seoul (KR)

(73) Assignee: B&L BIOTECH, INC., Ansan-si (KR)

(21) Appl. No.: 16/442,677

(22) Filed: Jun. 17, 2019

(30) Foreign Application Priority Data
Oct. 23, 2018 (KR) 10-2018-0126798

(51) Int. Cl. A61C 1/07; A61C 5/00

(52) U.S. Cl. CPC A61C 1/07; A61C 5/00

(57) ABSTRACT

Disclosed is a vibration apparatus for dental care including a body in which a vibrator is embedded; a tip part connected to the body to extend to an outside of the body and configured to transmit vibration energy of the vibrator to a resin applied to a tooth; and a controller configured to control a magnitude of vibration energy generated from the vibrator and transmitted to the tip part, wherein the controller controls a vibration frequency of the tip part within a range of 3 to 70 Hz. According to such configuration, the viscosity of resin attached to a tooth is lowered so that the resin can be easily formed into a desired shape and the tooth can be treated without generation of voids in the resin.

### CROSS-REFERENCE TO RELATED APPLICATION

This application claims the priority benefit of Korean Patent Application No. 10-2018-0126798, filed on Oct. 23, 2018 in the Korean Intellectual Property Office, the disclosure of which is incorporated herein by reference.

### BACKGROUND OF THE DISCLOSURE

### Field of the Disclosure

The present disclosure relates to a vibration apparatus for dental care, and more particularly to a vibration apparatus for dental treatment configured to transmit vibration in a set vibration frequency range to control the viscosity of a resin.

### Description of the Related Art

Various instruments have been developed and used for dental treatment. In particular, resins have been used for cavity treatment or orthodontic treatment. Resins generally used in dental hospitals have light transmittance similar to that of natural teeth and a variety of saturations. Such a resin is attached to teeth after performing acid etching treatment on tooth dentin and/or enamel to remove organic matter, such as food waste, therefrom, thereby restoring the teeth. In such a tooth restoration process, a tooth cavity is formed, and then a resin is attached to the cavity. To perform this process, instruments for dental treatment are used.

More particularly, a resin is applied to entrances of tubules to fill or close the tubules formed in tooth enamel or dentin after forming a cavity in a tooth. Here, a bonding agent may be applied to a tooth before application of a resin thereto. When a resin is attached to a tooth after such acid etching treatment, the resin is repeatedly applied in multip partle layers to the tooth so as to suppress generation of spaces or air bubbles therebetween. Resins can be classified into a flowable type, which is a liquid or is similar to a liquid, and a non-flowable type. Such resins are kneaded in a container, and then applied to a tooth by means of an instrument.

Meanwhile, when an instrument is removed after attaching a resin to a tooth, spaces or air bubbles may be formed between resin layers partially attached to the instrument. In addition, air bubbles may be formed inside a resin in a process of repeatedly attaching the resin in multiple layers to a tooth. Air bubbles generated during such a tooth treatment process using a resin may cause sharp pain or separation of the resin from a tooth. Accordingly, various research has been continuously carried out for effective attachment of a resin during dental treatment.

### RELATED ART DOCUMENT

### Patent Document

Korean Patent Application Publication No. 10-2011-0115645

U.S. patent application Ser. No. 11/429,290

### SUMMARY OF THE DISCLOSURE

Therefore, the present invention has been made in view of the above problems, and it is one object of the present invention to provide a vibration apparatus for dental care capable of controlling the viscosity of a resin applied to a tooth to allow easy forming of the resin.

It is another object of the present invention to provide a vibration apparatus for dental care capable of removing voids inside a resin by lowering the viscosity of the resin to improve the quality of treatment.

In accordance with an aspect of the present invention, the above and other objects can be accomplished by the provision of a vibration apparatus for dental care including a body in which a vibrator is embedded; a tip part connected to the body to extend to an outside of the body and configured to transmit vibration energy of the vibrator to a resin applied to a tooth; and a controller configured to control a magnitude of vibration energy generated from the vibrator and transmitted to the tip part, wherein the controller controls a vibration frequency of the tip part within a range of 3 to 70 Hz.

In accordance with an aspect, the vibrator may include a vibration motor configured to generate vibration energy.

In accordance with an aspect, the tip part may include a vibration tip connected to one side of the body and extending outside of the body; and a vibration bushing configured to add mass to the vibration tip.

In accordance with an aspect, the vibration bushing may be provided to be spaced apart from the vibrator by a predetermined distance.

In accordance with an aspect, the controller may include a microcomputer configured to control operation of the vibrator and a vibration frequency of the vibration tip within a range of 3 to 70 Hz.

In accordance with an aspect, the controller may sense a vibration frequency of the vibration tip and, when the vibration frequency of the vibration tip is outside a range of 3 to 70 Hz, a display window provided in the body may indicate that the vibration frequency of the vibration tip is outside of the range.

In accordance with an aspect, the controller may include a control switch provided in the body and manipulated by a user for input of a control signal, wherein, when the control switch is manipulated in a state in which the display window displays that a vibration frequency of the vibration tip is outside of the range, the controller may control the vibration energy of the vibrator to adjust the vibration frequency of the vibration tip within a range of 3 to 70 Hz.

In accordance with an aspect, the controller may serve to control a vibration frequency of the tip part within a range of 10 to 70 Hz.

In accordance with another aspect of the present invention, there is provided a vibration apparatus for dental care including a body having a space therein; a vibrator provided in the body and configured to generate vibration energy; and a tip part connected to the body to receive vibration energy from the vibrator and extending outside of the body, wherein the tip part transmits vibration energy having a vibration frequency of 3 to 70 Hz to a resin applied to a tooth.

In accordance with an aspect, the tip part may include a vibration tip connected to one side of the body and extending outside of the body; a vibration bushing configured to add mass to the vibration tip; and a vibration tip rotation operator provided between the vibration tip and the vibration bushing to rotate the vibration tip to a desired position.

In accordance with an aspect, the vibrator may include a vibration motor.

In accordance with an aspect, the vibration apparatus may further include a controller configured to control vibration energy generated from the vibrator, wherein the controller includes a microcomputer provided in the body.

In accordance with an aspect, the microcomputer may serve to control a vibration frequency of the vibration tip within a range of 3 to 70 Hz.

In accordance with an aspect, the controller may sense a vibration frequency of the vibration tip and, when the vibration frequency of the vibration tip is outside a range of 3 to 70 Hz, a display window provided in the body may display that the vibration frequency of the vibration tip is outside of the range.

In accordance with an aspect, the controller may include a control switch provided in the body and manipulated by a user for input of a control signal, wherein, when the control switch is manipulated in a state in which the display window displays that a vibration frequency of the vibration tip is outside of the range, the controller controls the vibration energy of the vibrator to adjust the vibration frequency of the vibration tip within a range of 3 to 70 Hz.

In accordance with an aspect, the controller may serve to control a vibration frequency of the tip part within a range of 10 to 70 Hz.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a schematic view of a vibration apparatus for dental care according to an exemplary embodiment of the present disclosure;

FIG. 2 illustrates a schematically exploded perspective view of the vibration apparatus for dental care according to the exemplary embodiment of FIG. 1;

FIG. 3 illustrates a schematic front view of the vibration apparatus for dental care according to the exemplary embodiment of FIG. 2; and

FIG. 4 is a graph schematically illustrating change in the viscosity of a resin dependent upon a vibration frequency of a vibration apparatus for dental care according to an exemplary embodiment of the present disclosure.

### DETAILED DESCRIPTION OF THE DISCLOSURE

Hereinafter, exemplary embodiments of the present disclosure are described in detail with reference to the accompanying drawings. However, it should be understood that the spirit and scope of the present disclosure are not limited to the embodiments and can be modified by addition, modification, or deletion of elements constituting the embodiments and such additions, modifications, and deletions are also within the spirit and scope of the present disclosure.

Hereinafter, the present disclosure is described in detail with reference to the accompanying drawings.

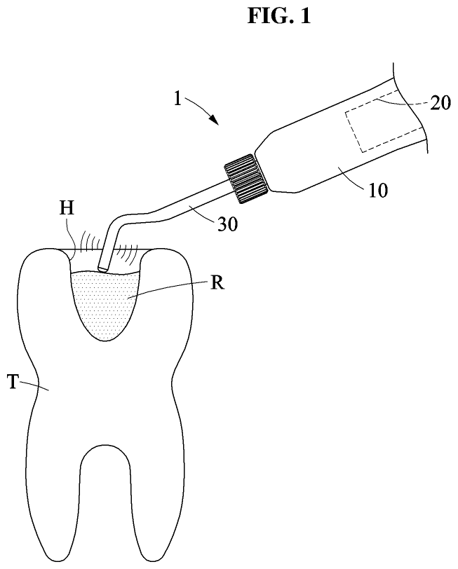

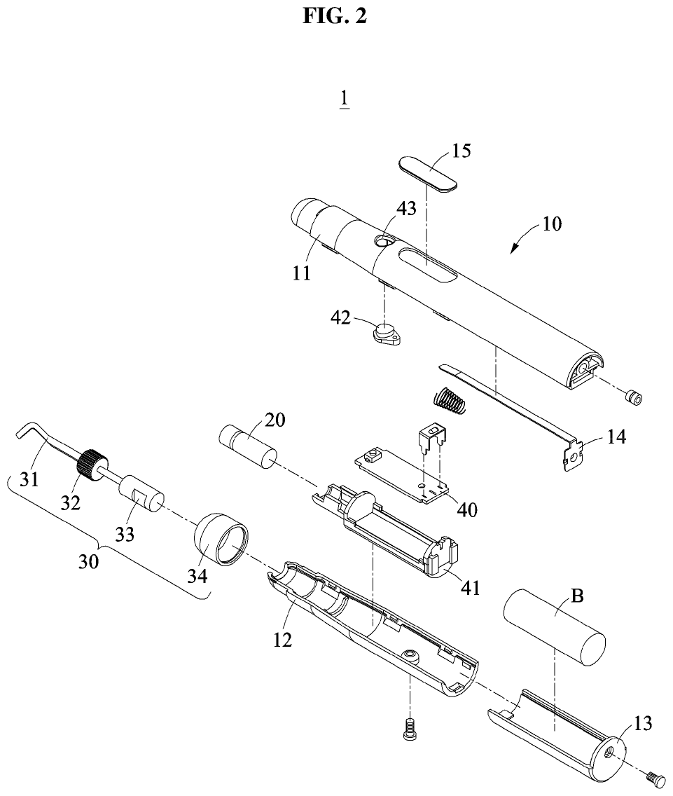

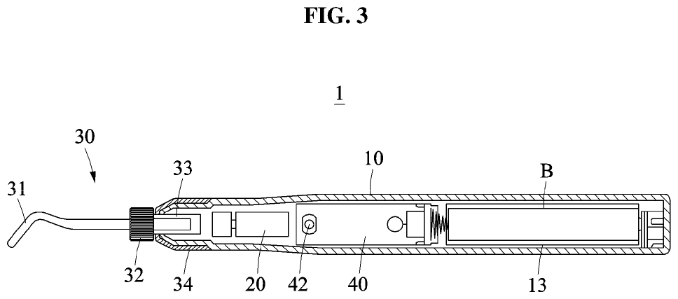

FIG. 1 schematically illustrates an operation of attaching a resin R to a cavity groove H of a tooth T by means of a vibration apparatus 1 for dental care according to an exemplary embodiment of the present disclosure, and FIG. 2 illustrates a schematically exploded perspective view of the vibration apparatus 1 for dental care shown in FIG. 1. In addition, FIG. 3 illustrates a schematic front view of the vibration apparatus 1 for dental care shown in FIG. 2.

Referring to FIGS. 1 and 2, the vibration apparatus 1 for dental care according to an embodiment of the present disclosure includes a body 10, a tip part 30, and a controller 40.

The body 10 includes a vibrator 20 embedded therein. As shown in FIG. 2, the body 10 includes housings 11 and 12 and a power supply 13. More particularly, the housings 11 and 12 are upper and lower housings separated from each other so as to be mutually engageable and include a space therein. In the space, the vibrator 20 is accommodated.

The vibrator 20 accommodated in the upper and lower housings 11 and 12 of the body 10 may include a vibration motor configured to generate vibration. The vibrator 20 may be any motor so long as it can generate vibration. An eccentric rotation motor is exemplified as an embodiment, but the present disclosure is not limited thereto. Of course, any one of various vibration generation motors such as a linear vibration motor may be adopted.

The power supply 13 is provided to be engaged with the lower housings 12 to supply power to the vibrator 20. The power supply 13 includes a battery housing configured to accommodate a battery B. Here, the battery B is connected to a power supply terminal 14 to supply power to the vibrator 20.

Meanwhile, the power supply 13 is illustrated and exemplified as receiving power from the embedded battery B in the embodiment, but the present disclosure is not limited thereto. That is, a modified embodiment, wherein the vibrator 20 receives power from the outside, not from the embedded battery B, is applicable.

For reference, symbol 15, which has not been described, of FIG. 2 denotes a display window provided at the upper housing 11.

The tip part 30 is connected to the body 10 to extend to the outside of the body 10 as shown in FIG. 1 so that vibration energy of the vibrator 20 is transmitted to the resin R coated on the tooth T. Here, the resin R is applied to a cavity groove H formed for treatment of the tooth T, and the tip part 30 contacts the resin R in the resin R-applied state so that the vibration energy is transmitted to the resin R.

The tip part 30 includes a vibration tip 31, a tip-engaging part 34, and a vibration bushing 33.

The vibration tip 31 extends to the outside of the body 10. Here, the vibration tip 31 transmits vibration from the vibrator 20 to the resin R contacting the vibration tip 31. For this, the vibration tip 31 is elongated in a longitudinal direction. The vibration tip 31 preferably has a bent end extended therefrom to facilitate contact with the resin R.

The tip-engaging part 34 couples the vibration tip 31 to one side of the body 10. As shown in FIGS. 2 and 3, the tip-engaging part 34 may be coupled to one side of the upper and lower housings 11 and 12 in a state where the upper and lower housings 11 and 12 are coupled to each other, so that the vibration tip 31 can be coupled to the upper and lower housings 11 and 12 in the coupled state of the upper and lower housings 11 and 12.

The vibration bushing 33 adds mass to the vibration tip 31. As shown in FIG. 3, the vibration bushing 33 is coupled to one end of the vibration tip 31 to reduce a vibration frequency of the vibration tip 31. That is, the vibration bushing 33 serves to increase a total mass of the connected vibration tip 31, thereby reducing a vibration frequency of the vibration tip 31. For reference, when a vibration frequency of the vibrator 20 is not appropriately controlled, a desired vibration frequency of the vibration tip 31 may be generated by adjusting the mass of the vibration bushing 33.

Meanwhile, the vibration bushing 33 is preferably provided to be spaced apart from the vibrator 20 by a predetermined distance. Due to the distance between the vibrator 20 and the vibration bushing 33, vibration generated from the vibrator 20 is effectively transmitted to the vibration bushing 33 via the upper and lower housings 11 and 12 of the body 10 so that the vibration tip 31 vibrates according to the vibration of the vibration bushing 33.

In addition, a vibration tip rotation operator 32 configured to rotate together with the vibration tip 31 may be further provided between the vibration tip 31 and the vibration bushing 33. The vibration tip rotation operator 32 is fixedly coupled to the vibration tip 31 so that the vibration tip 31 also rotates together with the vibration tip rotation operator 32 upon rotation of the vibration tip rotation operator 32. Accordingly, a user may rotate the vibration tip 31 to a desired position through the vibration tip rotation operator 32 so that a position of an end of the vibration tip 31 may be changed to contact the resin R.

The controller 40 is electrically connected to the vibrator 20 to control the magnitude of vibration energy of the vibrator 20, thereby controlling the magnitude of vibration transmitted to the tip part 30. Here, the controller 40 controls a vibration frequency transmitted to the tip part 30 within a range of 3 to 70 Hz. The viscosity of the resin R may be controlled by adjusting the magnitude of vibration energy transmitted to the tip part 30 by the controller 40.

The controller 40 is accommodated in the body 10 so that a microcomputer configured to receive power from the power supply 13 including the battery B is included. In addition, the controller 40 including the microcomputer is seated in the microcomputer holder 41 and thus accommodated in the body 10, thereby controlling the generation of vibration by a control switch 42.

For example, a user can manipulate the control switch 42 to turn the operation of the vibrator 20 on/off.

Here, the controller 40 serves to control a range of vibration frequencies, generated by the vibrator 20 and transmitted to the tip part 30, to 3 to 70 Hz.

More particularly, when a user first manipulates the control switch 42 to generate a control signal, the vibrator 20 may start to vibrate and a vibration frequency of 3 to 70 Hz may be generated by the vibration of the vibrator 20.

The controller 40 may sense the vibration frequency of the vibration tip 31. More particularly, the controller 40 may sense the vibration frequency of the vibration tip 31 also during dental treatment where the vibration tip 31 contacts the resin R.

When the controller 40 determines that the vibration frequency of the vibration tip 31 is outside of the preset range, i.e., a range of 3 to 70 Hz, a display window 15 may inform the outside that the vibration frequency of the vibration tip 31 is outside of a normal range.

When the display window 15 indicates that the vibration frequency of the vibration tip 31 is outside of a normal range, a user may manipulate the control switch 42 so that the controller 40 controls vibration energy of the vibrator 20 to adjust the vibration frequency of the vibration tip 31 within a range of 3 to 70 Hz.

For example, when a user manipulates the control switch 42 in the case wherein the vibration frequency of the vibration tip 31 is less than 3 Hz, the controller 40 increases the vibration energy of the vibrator 20 to adjust the vibration frequency of the vibration tip 31 within a range of 3 to 70 Hz. When the vibration frequency of the vibration tip 31 is greater than 70 Hz, the controller 40 lowers the vibration energy of the vibrator 20 to adjust the vibration frequency of the vibration tip 31 within a range of 3 to 70 Hz.

Alternatively, even when a user does not manipulate the control switch 42, the controller 40 may control the vibration energy of the vibrator 20 such that the vibration frequency of the vibration tip 31 is within a range of 3 to 70 Hz.

In addition, although not illustrated in detail, the control switch 42 may rotate or slide so that the controller 40 controls the vibration frequency to increase or decrease according to the rotation or sliding direction.

For reference, the vibration frequency of vibration energy generated from the vibrator 20 including the vibration motor is relatively larger than the vibration frequency of vibration energy transmitted to the vibration tip 31. That is, the vibration energy of the vibrator 20 is sequentially reduced via the body 10 and the vibration bushing 33 and is transmitted to the vibration tip 31. The vibration frequency of such vibration energy transmitted to the vibration tip 31 is within a range of 3 to 70 Hz.

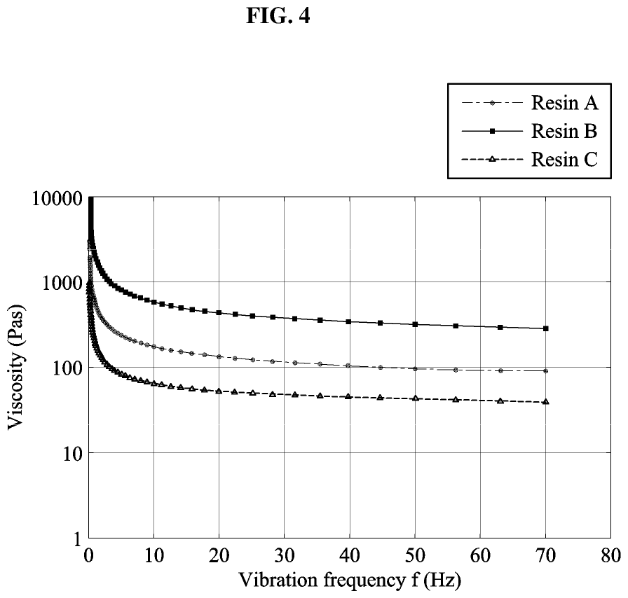

Referring to the graph of FIG. 4, viscosity changes according to vibration frequencies of the vibration tip 31 using various resin types R are schematically illustrated.

From the graph of FIG. 4, it can be confirmed that, when the vibration tip 31 transmits vibration energy to the resin R in a vibration frequency range of 3 to 70 Hz, the viscosity of the resin R is significantly decreased and a change in the viscosity becomes almost constant. Since the resin R is applied to the cavity groove H formed in the tooth T of FIG. 1 and then should be formed into the shape of the tooth T in a short time, the viscosity of the resin R is preferably low and uniform. Accordingly, as shown in the graph of FIG. 4, when vibration energy is applied in a frequency range of 3 to 70 Hz by the vibration tip 31 and thus the viscosity of the resin R is lowered and becomes uniform with little change, the resin R may be formed in a uniform shape while air is removed therefrom.

That is, the resin R may be formed in low viscosity, i.e., in a dilute state, due to the vibration frequency applied to the resin R by the vibration tip 31. In addition, the resin R having low and uniform viscosity is slowly hardened to penetrate without voids to a desired depth in a desired shape before hardening thereof.

Meanwhile, in the embodiment, the vibration frequency, which is generated by the vibrator 20 and transmitted to the vibration tip 31, is 3 to 70 Hz, more preferably 10 to 70 Hz.

In other words, the viscosity of the resin R greatly changes when the vibration frequency of the vibration tip 31 is smaller than 3 Hz, but the viscosity of the resin R is gently decreased as the vibration frequency becomes 3 Hz or more. In addition, when the vibration frequency of the vibration tip 31 is 10 Hz or more, the viscosity of the resin R becomes lowest, thus being uniform.

In addition, when the vibration frequency of the vibration tip 31 is higher than 70 Hz, a vibration transmitted to a tooth through the vibration tip 31 is too large, which may make the tooth uncomfortable and a user grasping and using the vibration apparatus 1 for dental care uncomfortable. Accordingly, the vibration frequency of the vibration tip 31 is preferably 70 Hz or less.

Now, an operation procedure of the vibration apparatus 1 for dental care according to an exemplary embodiment of the present disclosure is described with reference to FIG. 1.

As shown in FIG. 1, a cavity groove H is formed in a tooth T to be treated, and then a resin R is applied to the cavity groove H. Although the resin R is not illustrated in detail, it may be thinly applied several times.

When the resin R is applied to the cavity groove H, a vibration tip 31 of a tip part 30 comes into contact with the resin R to transmit vibration energy of the vibration tip 31 to the resin R. Here, the vibration frequency of the vibration energy transmitted to the resin R via the vibration tip 31 is in a range of 3 to 70 Hz. The viscosity of the resin R is lowered due to the vibration energy transmitted thereto (see graph of FIG. 4) so that air such as air bubbles in the resin R is removed therefrom. Accordingly, the resin R may be formed in a desired shape without voids therein.

In accordance with the present disclosure having the aforementioned configuration, first, the viscosity of a resin can be lowered by transmitting vibration to a resin in a preset vibration frequency range of 3 to 70 Hz. Since a resin having a low viscosity can be formed to the shape of a tooth in a short time, the resin can penetrate a cavity groove of the tooth regardless of the depth thereof.

Second, air bubbles inside a resin can be discharged to the outside by using a resin with a low viscosity, which allows treatment with a resin without voids. Accordingly, existing problems, such as sharp pain in a tooth and resin separation, due to voids in a resin after dental treatment can be addressed, which improves the reliability of dental treatment.

While the present invention has been described referring to the exemplary embodiments, those skilled in the art will appreciate that many modifications and changes can be made to the present invention without departing from the spirit and essential characteristics of the present invention.

### DESCRIPTION OF SYMBOLS

1: VIBRATION APPARATUS FOR DENTAL CARE
10: BODY
11: UPPER HOUSING
12: LOWER HOUSING
20: VIBRATOR
30: TIP PART
31: VIBRATION TIP
32: VIBRATION TIP ROTATION OPERATOR
33: VIBRATION BUSHING
40: CONTROLLER
T: TOOTH
H: CAVITY GROOVE
R: RESIN

What is claimed is:

1. A vibration apparatus for dental care, comprising:
a body in which a vibrator is embedded;
a tip part connected to the body to extend to an outside of the body and configured to transmit vibration energy of the vibrator to a resin applied to a tooth; and
a controller configured to control a magnitude of vibration energy generated from the vibrator and transmitted to the tip part,
wherein the controller controls a vibration frequency of the tip part within a range of 3 to 70 Hz.

2. The vibration apparatus according to claim 1, wherein the vibrator comprises a vibration motor configured to generate vibration energy.

3. The vibration apparatus according to claim 1, wherein the tip part comprises:
a vibration tip connected to one side of the body and extending outside of the body; and
a vibration bushing configured to add mass to the vibration tip.

4. The vibration apparatus according to claim 3, wherein the vibration bushing is provided to be spaced apart from the vibrator by a predetermined distance.

5. The vibration apparatus according to claim 1, wherein the controller comprises a microcomputer configured to control operation of the vibrator and a vibration frequency of the vibration tip within a range of 3 to 70 Hz.

6. The vibration apparatus according to claim 5, wherein the controller senses a vibration frequency of the vibration tip and, when the vibration frequency of the vibration tip is outside a range of 3 to 70 Hz, a display window provided in the body displays that the vibration frequency of the vibration tip is outside of the range.

7. The vibration apparatus according to claim 6, wherein the controller comprises a control switch provided in the body and manipulated by a user for input of a control signal, wherein, when the control switch is manipulated in a state in which the display window displays that a vibration frequency of the vibration tip is outside of the range, the controller controls the vibration energy of the vibrator to adjust the vibration frequency of the vibration tip within a range of 3 to 70 Hz.

8. The vibration apparatus according to claim 1, wherein the controller serves to control a vibration frequency of the tip part within a range of 10 to 70 Hz.

9. A vibration apparatus for dental care, comprising:
a body having a space therein;
a vibrator provided in the body and configured to generate vibration energy; and
a tip part connected to the body to receive vibration energy from the vibrator and extending outside of the body,
wherein the tip part transmits vibration energy having a vibration frequency of 3 to 70 Hz to a resin applied to a tooth.

10. The vibration apparatus according to claim 9, wherein the tip part comprises:
a vibration tip connected to one side of the body and extending outside of the body;
a vibration bushing configured to add mass to the vibration tip; and
a vibration tip rotation operator provided between the vibration tip and the vibration bushing to rotate the vibration tip to a desired position.

11. The vibration apparatus according to claim 9, wherein the vibrator comprises a vibration motor.

12. The vibration apparatus according to claim 9, further comprising a controller configured to control vibration energy generated from the vibrator,
wherein the controller comprises a microcomputer provided in the body.

13. The vibration apparatus according to claim 12, wherein the microcomputer serves to control a vibration frequency of the vibration tip within a range of 3 to 70 Hz.

14. The vibration apparatus according to claim 13, wherein the controller senses a vibration frequency of the vibration tip and, when the vibration frequency of the vibration tip is outside a range of 3 to 70 Hz, a display window provided in the body displays that the vibration frequency of the vibration tip is outside of the range.

15. The vibration apparatus according to claim 14, wherein the controller comprises a control switch provided in the body and manipulated by a user for input of a control signal,
wherein, when the control switch is manipulated in a state in which the display window displays that a vibration frequency of the vibration tip is outside of the range, the controller controls the vibration energy of the vibrator to adjust the vibration frequency of the vibration tip within a range of 3 to 70 Hz.

16. The vibration apparatus according to claim 13, wherein the controller serves to control a vibration frequency of the tip part within a range of 10 to 70 Hz.
